(19) United States
(12) Patent Application Publication
(10) Pub. No.: US 2008/0178150 A1
(43) Pub. Date: Jul. 24, 2008

(54) Complex time zone techniques

(75) Inventors: Katherine E. King, Seattle, WA (US); Anthony J. Moore, Seattle, WA (US); Shawn C. Steele, Bellevue, WA (US); Kathy K. Kam, Redmond, WA (US); Josh Free, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/655,379

(22) Filed: Jan. 19, 2007

(51) Int. Cl. G06F 9/44

(52) U.S. Cl. 717/114; 719/328

(57) ABSTRACT

Various technologies and techniques are disclosed that provide support for complex time zones. A framework environment has a time zone API that supports complex time zones. The time zone class allows zero or more adjustment rules to be specified for the time zone object to indicate any daylight saving time adjustments. A feature is provided to allow the time zone to be serialized into a string. When the feature receives a request to serialize a particular time zone to a string, the time zone is serialized to the string. The string contains a certain number of interior records that describe zero or more details about the time zone, the certain number being dependent upon a complexity of the particular time zone. A custom time zone feature is supported that allows a complex time zone to be created programmatically from within an application.

### BACKGROUND

Software development frameworks such as the MICROSOFT® .NET Framework and Java provide platforms for allowing developers to create and run applications. Such frameworks provide some support for different time zones, such as the conversion from a local time zone into a coordinated universal time (UTC). With today's world of technology, it is very common for the user to be located in a different time zone and possibly even a different country than one or more servers that are running a particular application, such as over the Internet. These applications running on remote servers need to have some way of translating the date/time information into values that are meaningful to a user—e.g. the user's time zone.

Some platform environments require the developer of the application to write custom code to translate from the server's time zone to a local or custom time zone. When daylight saving time rules are involved, this process becomes even more tedious for the developer. Further improvements are needed to make the process of creating and managing time zones in applications easier for today's distributed world.

### SUMMARY

Various technologies and techniques are disclosed that provide support for complex time zones. A framework environment has a time zone API that supports complex time zones. The time zone class allows zero or more adjustment rules to be specified for the time zone object to indicate any daylight saving time adjustments. A feature is provided to allow the time zone to be serialized into a string. When the feature receives a request to serialize a particular time zone to a string, the time zone is serialized to the string. The string contains a certain number of interior records that describe zero or more details about the time zone, the certain number being dependent upon a complexity of the particular time zone. In one implementation, the string can be de-serialized back into an original format from the same or different computer from the one it was created on.

A custom time zone feature is supported that allows a complex time zone to be created programmatically from within an application. In one implementation, the custom time zone contains one or more daylight saving time adjustments.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a framework application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in serializing a time zone into a string.

FIG. 5 is a process flow diagram for one implementation of the system of FIG. 1 illustrating the stages involved in providing a custom time zone feature.

FIG. 6 is an object diagram for one implementation of the system of FIG. 1 illustrating a time zone object and some of its related components.

FIG. 7 is an object diagram for one implementation of the system of FIG. 1 illustrating a time zone API and some of its related methods.

FIG. 8 is an object diagram for one implementation of the system of FIG. 1 illustrating an adjustment rule object and a method it supports.

FIG. 9 is an example of a time zone observing simple daylight saving time rules that has been serialized to a string for one implementation of the system of FIG. 1.

FIG. 10 is an example of a complex time zone that has been serialized to a string for one implementation of the system of FIG. 1.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as a framework environment that serves as a platform for developing and executing computer software applications, but the system also serves other purposes in addition to these. In one implementation, one or more of the techniques described herein can be implemented as features within a framework environment such as MICROSOFT® .NET Framework, Java, or from any other type of program or service that enable software development.

In one implementation, a time zone API is provided in a framework environment to support complex time zones. The term complex time zones as used herein is meant to include time zones whose rules for adjusting the date and time, such as for daylight saving time, vary depending on one or more ranges of dates. The API allows a developer to create a time zone object that can be used by an application to manage time zones within an application. For example, if a user of a web application is located in a different time zone than the server running the application is in, the application can use a convert method of the API to convert from the server's local time to the user's local time. The user's local time can then be displayed to the user, which is much more meaningful to the user than the server's time. In another implementation, the API supports serializing a time zone to a string that has a certain number (e.g. variable) number of interior records depending on the complexity of the time zone. For example, in the case of a time zone that does not observe daylight saving time, there may be no interior records in the string. In the case of a complex time zone that does observe daylight saving time, there may be one or more interior records in the string that describe those daylight saving time details. As one non-limiting example, there may be one interior record for each date range in which a different daylight saving time adjustment rule is used. By supporting serializing of a time zone to a string, the time zone can easily be transferred to another computer and/or process that can read the plain text and operate upon that information. In yet another implementation, the user is able to create custom complex time zones programmatically.

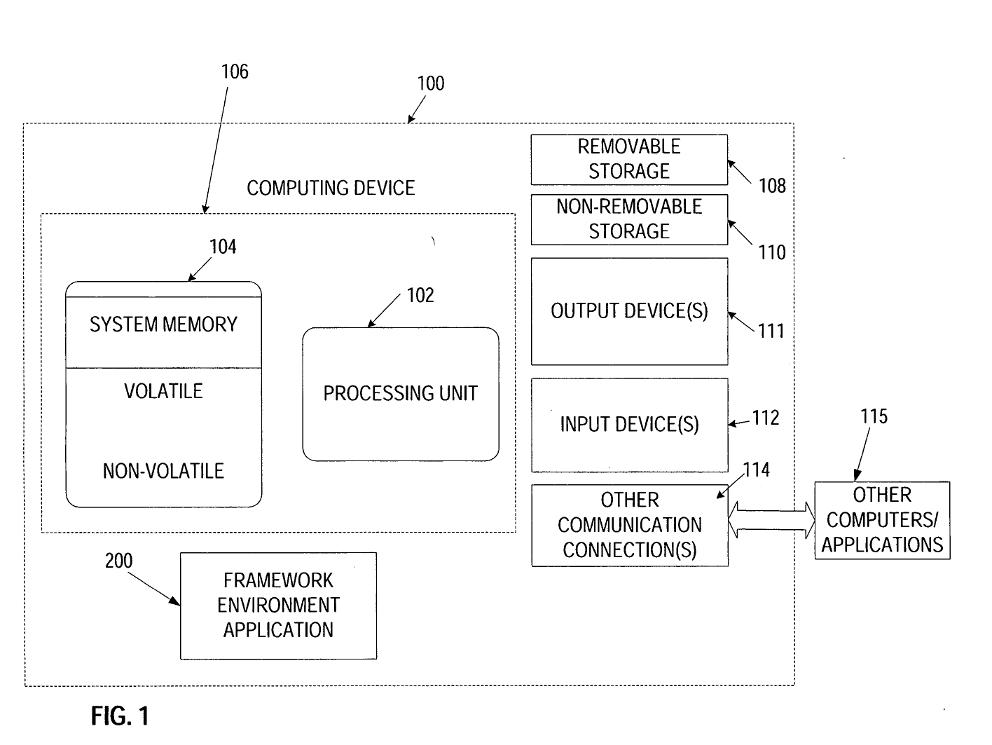

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

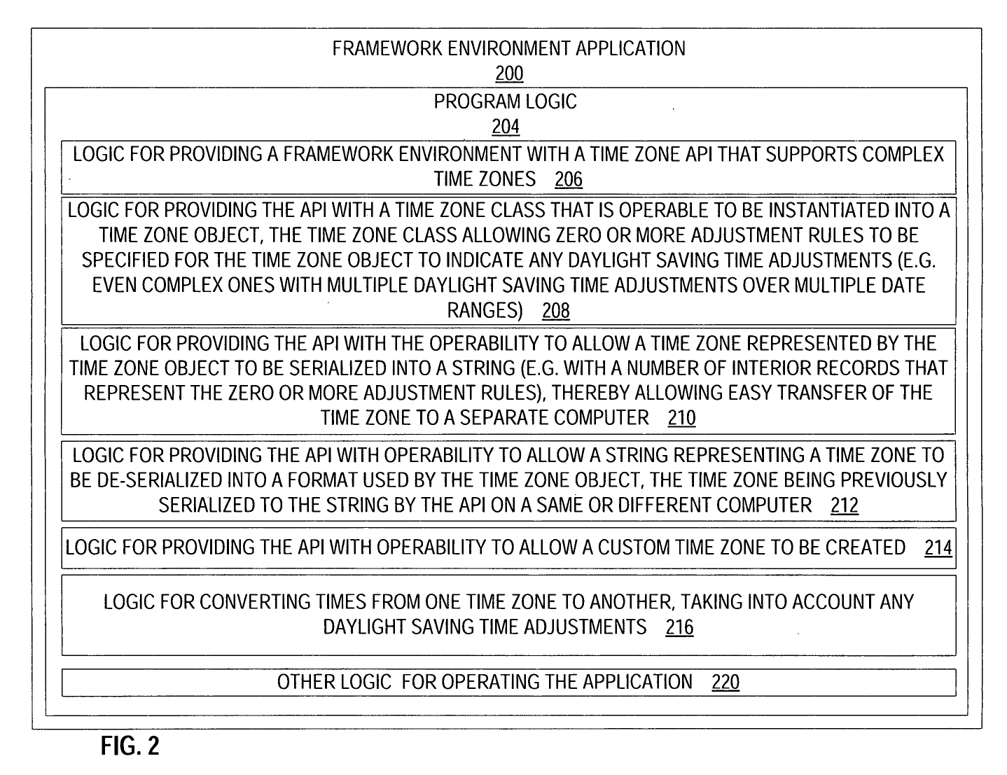

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes framework environment application 200. Framework environment application 200 will be described in further detail in FIG. 2.

Turning now to FIG. 2 with continued reference to FIG. 1, a framework environment application 200 operating on computing device 100 is illustrated. Framework environment application 200 is one of the application programs that reside on computing device 100. Alternatively or additionally, one or more parts of framework environment application 200 can be part of system memory 104, on other computers and/or applications 115, or other such variations as would occur to one in the computer software art.

Framework environment application 200 includes program logic 204, which is responsible for carrying out some or all of the techniques described herein. Program logic 204 includes logic for logic for providing a framework environment with a time zone API that supports complex time zones 206; logic for providing the API with a time zone class that is operable to be instantiated into a time zone object, the time zone class allowing zero or more adjustment rules to be specified for the time zone object to indicate any daylight saving time adjustments (e.g. even complex ones with multiple daylight saving time adjustments over multiple year ranges) 208; logic for providing the API with the operability to allow a time zone represented by the time zone object to be serialized into a string (e.g. with a number of interior records that represent the zero or more adjustment rules), thereby allowing easy transfer of the time zone to a separate computer 210; logic for providing the API with operability to allow a string representing a time zone to be de-serialized into a format used by the time zone object, the time zone being previously serialized to the string by the API on a same or different computer 212; logic for providing the API with operability to allow a custom time zone to be created 214; logic for converting times from one time zone to another, taking into account any daylight saving time adjustments 216; and other logic for operating the application 220. In one implementation, program logic 204 is operable to be called programmatically from another program, such as using a single call to a procedure in program logic 204.

In one implementation, program logic 204 resides on computing device 100. However, it will be understood that program logic 204 can alternatively or additionally be embodied as computer-executable instructions on one or more computers and/or in different variations than shown on FIG. 2. Alternatively or additionally, one or more parts of framework environment application 200 can be part of system memory 104, on other computers and/or applications 115, or other such variations as would occur to one in the computer software art.

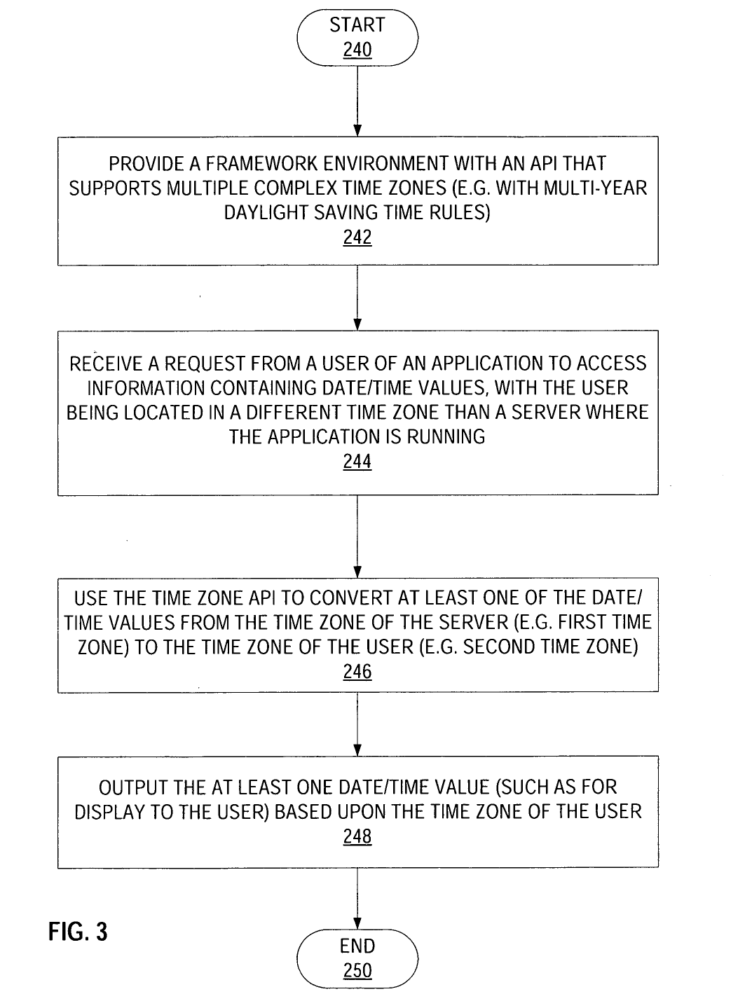

Turning now to FIGS. 3-5 with continued reference to FIGS. 1-2, the stages for implementing one or more implementations of framework environment application 200 are described in further detail. FIG. 3 is a high level process flow diagram for framework environment application 200. In one form, the process of FIG. 3 is at least partially implemented in the operating logic of computing device 100. The process begins at start point 240 with providing a framework environment with an API that supports multiple complex time zones (e.g. with multi-year daylight saving time rules) (stage 242). The system receives a request from a user of an application to access information containing date/time values, with the user being located in a different time zone than a server where the application is running (stage 244). The time zone API is used to convert at least one of the date/time values from the time zone of the server (e.g. first time zone) to the time zone of the user (e.g. second time zone) (stage 246). The at least one date/time value is outputted (such as for display to the user) based upon the time zone of the user (stage 248). The process ends at point 250.

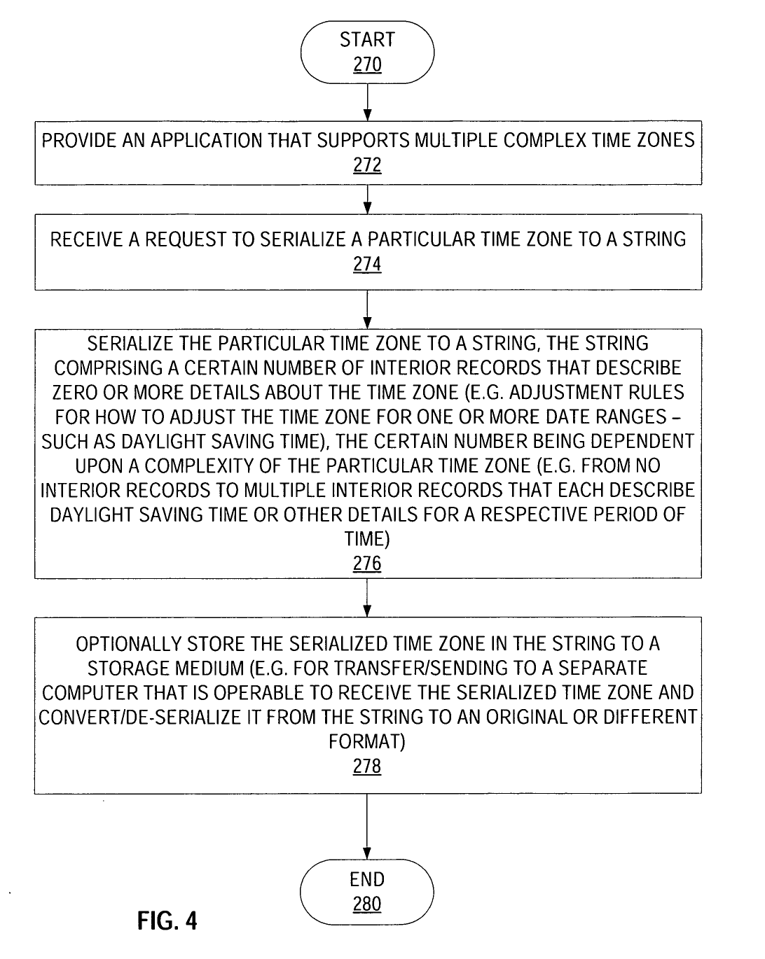

FIG. 4 illustrates one implementation of a more detailed process for serializing a time zone into a string. In one form, the process of FIG. 4 is at least partially implemented in the operating logic of computing device 100. The process begins at start point 270 with providing an application that supports multiple complex time zones (stage 272). The system receives a request to serialize a particular time zone to a string (stage 274). The particular time zone is serialized to a string that has a certain number of interior records that describe zero or more details about the time zone (stage 276). One non-limiting example of the contents of the interior records includes one or more adjustment rules that describe how to adjust the time zone for one or more date ranges—such as daylight saving time (stage 276).

In one implementation, the number of interior records present (e.g. whether it be 0, 1, or more) is dependent upon a complexity of the particular time zone (stage 276). For example, there could be as few as no interior records, to as many as multiple interior records (stage 276). In one implementation, in the case of multiple interior records, the records each describe daylight saving time or other adjustment details for a respective period of time for the time zone (stage 276). The serialized time zone is optionally stored in the string to a storage medium, such as for transfer/sending to a separate computer that is operable to receive the serialized time zone and convert/de-serialize it from the string to an original or different format (stage 278). The process ends at end point 280.

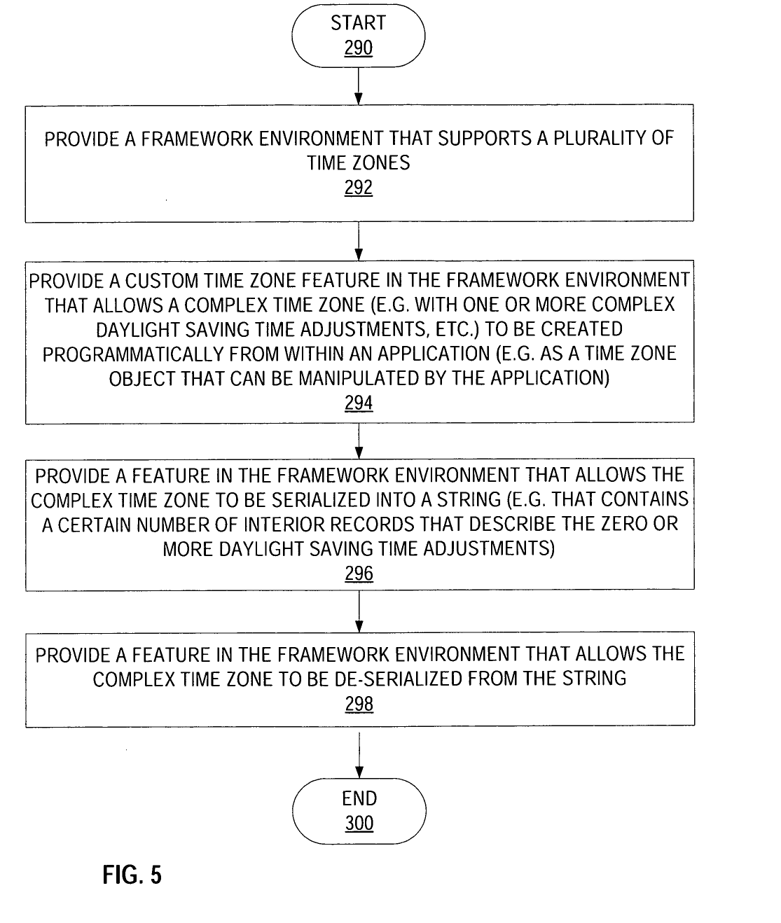

FIG. 5 illustrates one implementation of the stages involved in providing a custom time zone feature. In one form, the process of FIG. 5 is at least partially implemented in the operating logic of computing device 100. The process begins at start point 290 with providing a framework environment that supports a plurality of time zones (stage 292). A custom time zone feature is provided in the framework environment that allows a complex time zone (e.g. with one or more complex daylight saving time adjustments, etc.) to be created programmatically from within an application (stage 294). In one implementation, the complex time zone is created as a time zone object that can be manipulated by the application (stage 294). A feature is provided in the framework environment that allows the complex time zone to be serialized into a string (e.g. that contains a certain number of interior records that describe the zero or more daylight saving time adjustments) (stage 296). A feature is provided in the framework environment that allows the complex time zone to be de-serialized from the string (stage 298). The process then ends at end point 300.

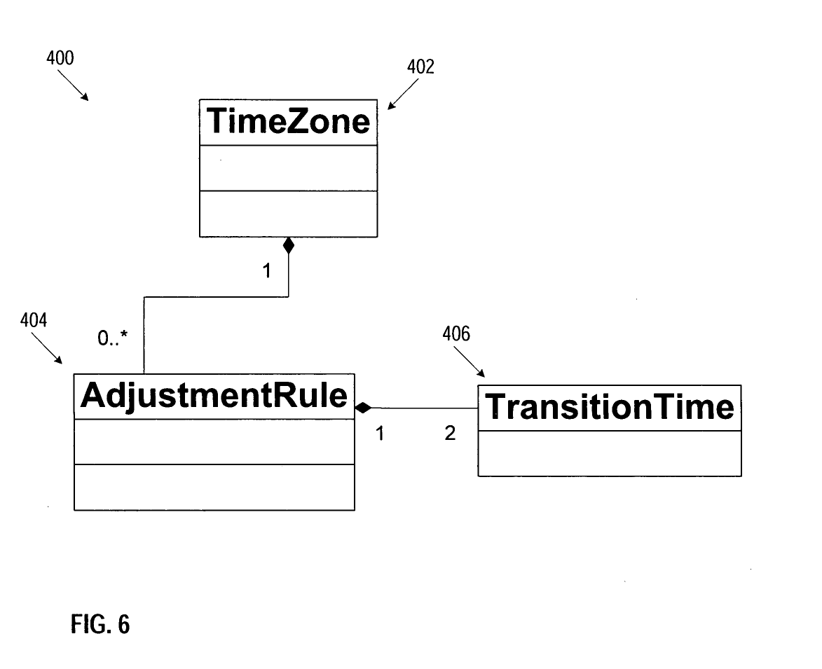

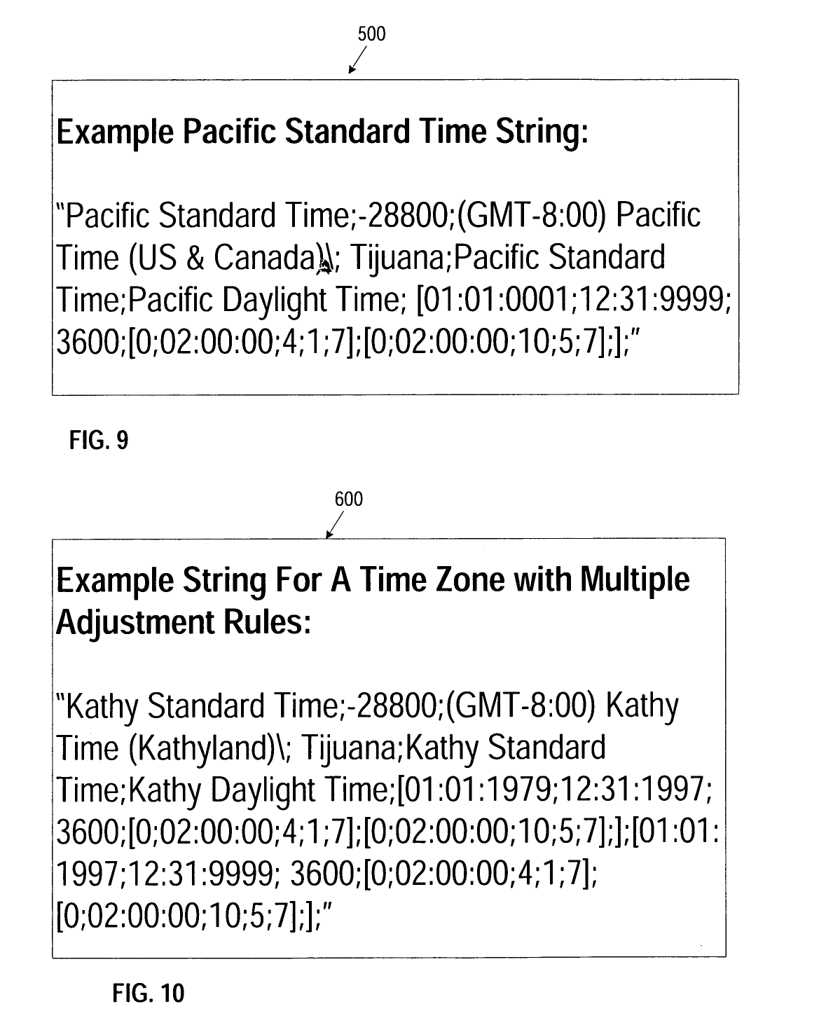

Turning now to FIGS. 6-8, object diagrams are illustrated to show some exemplary implementations of the time zone API described herein that is part of framework environment application 200. FIG. 6 is an object diagram for one implementation that illustrates a time zone object 400 and some of its related components. For each time zone 402, there will be zero to N adjustment rules 404. For each adjustment rule, there will be two transition times (e.g. a start and a stop) 406. As a non-limiting example, in the case of a simple time zone that does not observe daylight saving time, there will be a time zone object that does not have any adjustment rules, since that time zone does not need to be adjusted for daylight saving time. In the case of a time zone that has always observed the same daylight saving time rule, there will be one adjustment rule, and two transition times to describe the daylight savings rule. In the case of a complex time zone that has changed daylight saving time rules over a period of time, there will be N number of adjustment rules, plus 2 times N transition times specified to describe the time periods covered. The diagrams of FIGS. 9 and 10 illustrate these concepts using a string example.

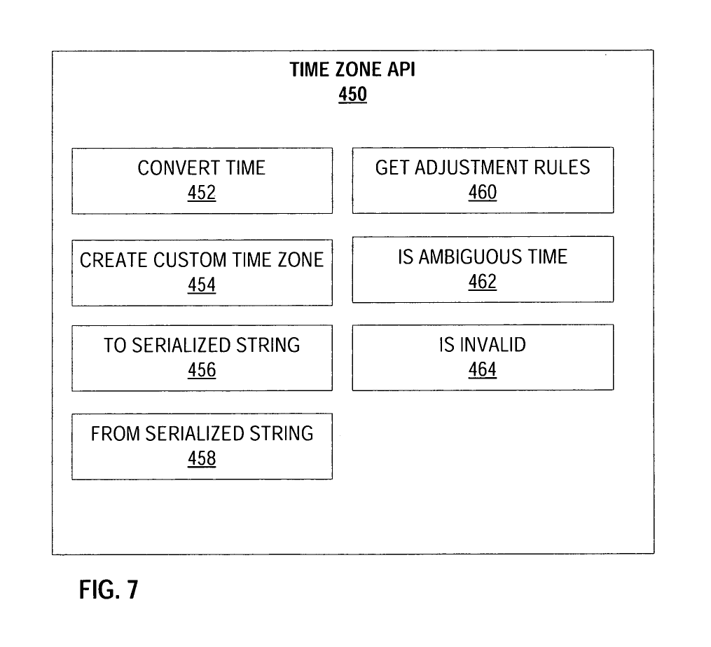

FIG. 7 is an object diagram for one implementation of the system of FIG. 1 illustrating a time zone API 450 and some of its related methods. In one implementation, time zone API 450 contains various methods that can be called when desired, such as a “convert time” method 452, a “create custom time zone” method 454, a “to serialized string” method 456, and a “from serialized string” method 458. The “convert time” method 452 can be called with one or more sets of parameters to indicate how a particular time should be converted from one time zone to another. The “create custom time zone” method 454 allows for programmatic creation of a custom time zone. The “to serialized string” method 456 allows for a time zone to be serialized to a string format as described in the process of FIG. 4 and as shown in FIGS. 9 and 10. The “from serialized string” method 458 allows for a time zone to be de-serialized from the string back into a time zone object or other format.

Alternatively or additionally, other methods can be provided by time zone API 450, such as “get adjustment rules” method 460, “is ambiguous time” method 462, and “is invalid” method 464. The “get adjustment rules” method 460 is used to retrieve the adjustment rules that are specified for a given time zone, such as those that describe the daylight saving time rules, if any. The “is ambiguous time” method 462 is used to determine whether a particular time is ambiguous in a given time zone, meaning that it can be mapped to two or more coordinated universal times (e.g. UTC times). For example, the “is ambiguous time” method 462 can be used to identify the duplicate hour when a time zone transitions from daylight saving time back to standard time (e.g. first 2 am is in daylight saving, second 2 am is in standard time). The “is invalid” method 464 is used to determine whether a particular time is invalid in the given time zone because the time cannot be mapped to any UTC time. For example, the “is invalid” method 464 can be used to identify the missing hour when a time zone transitions from standard time to daylight saving time (e.g. the missing 2 am when you move the clock forward 1 hour, when 1 am is followed by 3 am).

The methods shown in time zone API 450 and described herein are exemplary in nature. It will be appreciated by one of ordinary skill in the computer software art that in other implementations, some, all, fewer, and/or additional methods and/or features may be provided by time zone API 450.

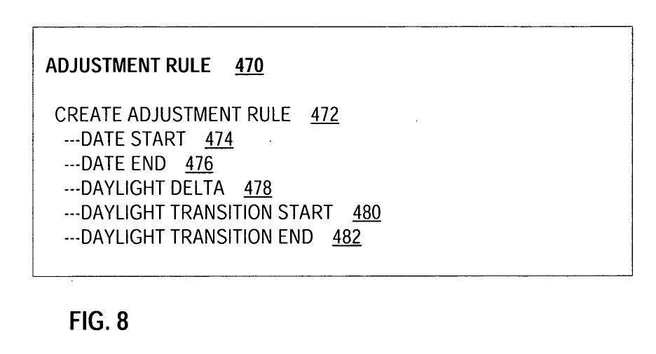

FIG. 8 is an object diagram for one implementation of the system of FIG. 1 illustrating an adjustment rule object 470 and a “create adjustment rule” method 472 that it supports. The “create adjustment rule” method 472 accepts various parameters, such as “date start” 474, “date end” 476, “daylight delta” 478, “daylight transition start” 480, “daylight transition end” 482. The “create adjustment rule” method 472 allows for the adjustment rules that describe one or more daylight saving time adjustments to be created for a particular time zone.

Turning now to FIGS. 9 and 10, example time zone strings of one implementation are shown that were created according the serialization process described in FIG. 4. FIG. 9 is an example of a time zone observing simple daylight saving time rules that has been serialized to a string 500. The example string 500 contains only one interior record that describes the single daylight saving time rule. The one interior record is indicated by the content in the outer-most brackets: [ ]. FIG. 10 is an example of a complex time zone observing multiple daylight saving time rules that has been serialized to a string 600. The example string 600 contains multiple interior records for describing multiple daylight saving time rules that span different ranges of years (again, as shown with the outer-most brackets: [ ]).

In one implementation (including those shown in FIGS. 9 and 10), the serialization strings have the following format:

<Id>;<BaseUtcOffset>;<DisplayName>;<StandardName>;
<DaylightName>;[
<DateStart>;<DateEnd>;<DaylightDelta>;[<TransitionTime>];
[<TransitionTime>]]

In one implementation, the <DateStart>, <DateEnd>, and <DaylightDelta> in the above example is taken from the AdjustmentRules class. In one implementation, there are two possible formats for the TransitionTime class, depending on whether the date is a fixed date or a floating date. In the case of a fixed date, the format is:

[<IsFixedDate>;<timeOfDay>;<Month>;<Day>].

In the case of a floating date, the format is:

[<IsFixedDate>;<timeOfDay>;<Month>;<Week>;<DayOfWeek>]

The formats shown above are just examples of how the serialized string is formatted in one implementation, and numerous other formats could be used in alternate implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for serializing a time zone into a string comprising the steps of:
providing an application that supports complex time zones;
receiving a request to serialize a particular time zone to a string; and
serializing the particular time zone to a string, the string comprising a certain number of interior records that describe zero or more details about the time zone, the certain number being dependent upon a complexity of the particular time zone.

2. The method of claim 1, further comprising:
storing the serialized time zone in the string to a storage medium.

3. The method of claim 1, wherein the serialized time zone in the string is operable to be transferred to a separate computer.

4. The method of claim 1, further comprising:
sending the serialized time zone in the string to a separate computer that is operable to receive the serialized time zone and convert the serialized time zone from the string to a different format.

5. The method of claim 1, wherein at least one of the certain number of interior records contains a daylight saving time adjustment rule.

6. The method of claim 1, wherein the certain number of interior records comprises a plurality of records that each describe daylight savings details for the time zone for a respective period of time.

7. The method of claim 1, further comprising
de-serializing the particular time zone from the string back into an original format.

8. The method of claim 1, wherein the certain number of interior records contain one or more adjustment rules that describe how to adjust the particular time zone for one or more date ranges.

9. A computer-readable medium having computer-executable instructions for causing a computer to perform the steps recited in claim 1.

10. A computer-readable medium having computer-executable instructions for causing a computer to perform steps comprising:
provide a framework environment with a time zone API that supports complex time zones, the time zone API comprising:
a time zone class that is operable to be instantiated into a time zone object, the time zone class allowing zero or more adjustment rules to be specified for the time zone object to indicate any daylight saving time adjustments.

11. The computer-readable medium of claim 10, wherein the API is operable to allow a plurality of adjustment rules to be specified for the time zone object to indicate multiple daylight saving time adjustments over multiple date ranges.

12. The computer-readable medium of claim 10, wherein the API is further operable to allow a time zone represented by the time zone object to be serialized to a string.

13. The computer-readable medium of claim 12, wherein the string contains a certain number of interior records that represent the zero or more adjustment rules.

14. The computer-readable medium of claim 12, wherein the serialized string is operable to be transferred to a separate computer.

15. The computer-readable medium of claim 10, wherein the API is further operable to allow a string representing a time zone to be de-serialized into a format used by the time zone object, the time zone being previously serialized to the string by the API on a same or different computer.

16. A method for providing custom time zones comprising the steps of:
providing a framework environment that supports a plurality of time zones; and
providing a custom time zone feature in the framework environment that allows a complex time zone to be created programmatically from within an application, the complex time zone containing one or more daylight saving time adjustments.

17. The method of claim 16, wherein the framework environment is operable to allow the complex time zone to be serialized to a string.

18. The method of claim 17, wherein the string contains a certain number of interior records that describe the one or more daylight saving time adjustments.

19. The method of claim 16, wherein the complex time zone is created as a time zone object that can be manipulated by the application.

20. A computer-readable medium having computer-executable instructions for causing a computer to perform the steps recited in claim 16.
